(19) United States
(12) Patent Application Publication
(10) Pub. No.: US 2022/0027770 A1
(43) Pub. Date: Jan. 27, 2022

(54) METHOD, APPARATUS, DEVICE AND STORAGE MEDIUM FOR INFORMATION PROCESSING

(71) Applicant: NEC CORPORATION, Tokyo (JP)

(72) Inventor: Zheng PAN, Beijing (CN)

(73) Assignee: NEC CORPORATION, Tokyo (JP)

(21) Appl. No.: 17/380,684

(22) Filed: Jul. 20, 2021

(30) Foreign Application Priority Data
Jul. 21, 2020 (CN) 202010706472.4

(51) Int. Cl. G06N 5/04; G06N 20/00; G06K 9/62

(52) U.S. Cl. CPC G06N 5/046; G06N 20/00; G06K 9/6234; G06K 9/6263; G06K 9/6256

(57) ABSTRACT

The present disclosure relates to a method, apparatus, device and storage medium for information processing. Specifically, a method is proposed for information processing. In the method, multiple observation samples associated with multiple factors of an application system are received, an observation sample among the multiple observation samples comprising a group of observation values of the multiple factors. At least one attribute of the multiple observation samples is obtained. At least one processing procedure is determined based on the at least one attribute, a processing procedure of the at least one processing procedure being used for processing the multiple observation samples to obtain a causality between the multiple factors. Further, there is provided an apparatus, device and storage medium for information processing. Based on input data to be processed, an algorithm for processing the input data may be automatically determined. In this way, on one hand, the reliance on human labor may be reduced, and on the other hand, the performance and accuracy of the data processing procedure may be increased.

### FIELD

Various implementations of the present disclosure relate to the field of machine learning, and more specifically, to a method, apparatus, device and computer storage medium for information processing based on machine learning technology.

### BACKGROUND

The machine learning technology has been widely applied in various fields so as to seek a causality between multiple factors. For example, in the field of mechanical manufacture, part blanks have to undergo processing stages to produce products that meet predetermined shape requirements. It will be understood that different control parameters may be involved in processing stages. Control parameters will directly or indirectly determine errors in final products. For another example, a power transmission system may involve a large number of transmission parameters, which might directly or indirectly determine power loss caused by transmission.

The causality serves as a basis for other subsequent processing and analysis. How to determine a more reliable causality based on input data will affect the accuracy of subsequent operations to some extent. Therefore, it is desirable to select appropriate processing procedures to process input data and further determine the causality between multiple factors in the input data.

### SUMMARY

Example implementations of the present disclosure provide a technical solution for information processing.

According to a first aspect of the present disclosure, a method is proposed for information processing. In the method, multiple observation samples associated with multiple factors of an application system are received, an observation sample among the multiple observation samples comprising a group of observation values of the multiple factors. At least one attribute of the multiple observation samples is obtained. At least one processing procedure is determined based on the at least one attribute, a processing procedure of the at least one processing procedure being used for processing the multiple observation samples to obtain a causality between the multiple factors.

According to a second aspect of the present disclosure, a device is proposed for information processing. The device comprises a processor, and the processor is configured to receive multiple observation samples associated with multiple factors of an application system, an observation sample among the multiple observation samples comprising a group of observation values of the multiple factors; obtain at least one attribute of the multiple observation samples; and determine at least one processing procedure based on the at least one attribute, a processing procedure of the at least one processing procedure being used to process the multiple observation samples so as to obtain a causality between the multiple factors.

According to a third aspect of the present disclosure, an electronic device is proposed. The device comprises: at least one processing unit; at least one memory, coupled to the at least one processing unit and storing instructions to be executed by the at least one processing unit, the instructions, when executed by the at least one processing unit, causing the device to perform a method according to the first aspect.

According to a fourth aspect of the present disclosure, a computer-readable storage medium is provided, containing computer-readable program instructions stored thereon which are used to perform a method according to the first aspect.

According to a fifth aspect of the present disclosure, a method is proposed for information processing. In the method, multiple observation samples associated with multiple factors of an application system are received, an observation sample among the multiple observation samples comprising a group of observation values of the multiple factors. The multiple observation samples are processed by multiple processing procedures respectively, so as to determine multiple causalities between the multiple factors, a causality among the multiple causalities being obtained based on a processing procedure among the multiple processing procedures.

According to a sixth aspect of the present disclosure, a device is proposed for information processing. The device comprises a processor, and the processor is configured to receive multiple observation samples associated with multiple factors of an application system, an observation sample among the multiple observation samples comprising a group of observation values of the multiple factors; process the multiple observation samples by multiple processing procedures respectively, so as to determine multiple causalities between the multiple factors, a causality among the multiple causalities being obtained based on a processing procedure among the multiple processing procedures.

According to a seventh aspect of the present disclosure, an electronic device is proposed. The device comprises: at least one processing unit; at least one memory, coupled to the at least one processing unit and storing instructions to be executed by the at least one processing unit, the instructions, when executed by the at least one processing unit, causing the device to perform a method according to the fifth aspect.

According to an eighth aspect of the present disclosure, a computer-readable storage medium is provided, containing computer-readable program instructions stored thereon which are used to perform a method according to the fifth aspect.

The Summary is to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

Through the more detailed description in the accompanying drawings, features, advantages and other aspects of implementations of the present disclosure will become more apparent. Several implementations of the present disclosure are illustrated schematically and are not intended to limit the present invention. In the drawings:

FIG. 1A schematically shows a block diagram of one application system in which example implementations of the present invention may be implemented;

FIG. 1B schematically shows a block diagram of another application system in which example implementations of the present invention may be implemented;

FIG. 2A schematically shows a block diagram of one computing environment according to example implementations of the present disclosure;

FIG. 2B schematically shows a block diagram of another computing environment according to example implementations of the present disclosure;

FIG. 3 schematically shows a block diagram of a process for information processing according to one implementation of the present disclosure;

FIG. 4 schematically shows a flowchart of a method for information processing according to one implementation of the present disclosure;

FIG. 5 schematically shows a block diagram of a processing procedure library according to one implementation of the present disclosure;

FIG. 6 schematically shows a block diagram of a data structure of a feature of multiple observation samples according to one implementation of the present disclosure;

FIG. 7 schematically show a block diagram of a user interface for information processing according to one implementation of the present disclosure;

FIGS. 8A, 8B and 8C schematically show a block diagram of a user interface for displaying a causality according to one implementation of the present disclosure, respectively;

FIG. 9 schematically shows a block diagram of an apparatus for information processing according to one implementation of the present disclosure; and

FIG. 10 shows a schematic block diagram of a device for information processing according to one implementation of the present disclosure.

### DETAILED DESCRIPTION OF IMPLEMENTATIONS

The preferred example implementations of the present disclosure will be described in more detail with reference to the drawings. Although the drawings illustrate the preferred example implementations of the present disclosure, it should be appreciated that the present disclosure can be implemented in various ways and should not be limited to the example implementations explained herein. On the contrary, these example implementations are provided to make the present disclosure more thorough and complete and to fully convey the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The terms “one example implementation” and “one implementation” are to be read as “at least one example implementation.” The term “a further example implementation” is to be read as “at least a further example implementation.” The terms “first”, “second” and so on can refer to same or different objects. The following text also can comprise other explicit and implicit definitions.

In some examples, a value, procedure or apparatus is considered as “optimal,” “lowest,” “highest,” “minimum,” “maximum,” etc. It should be understood that such description is intended to indicate a choice may be made among many functional alternatives, and such a choice does not need to be better, smaller, higher, or otherwise preferred than other choices.

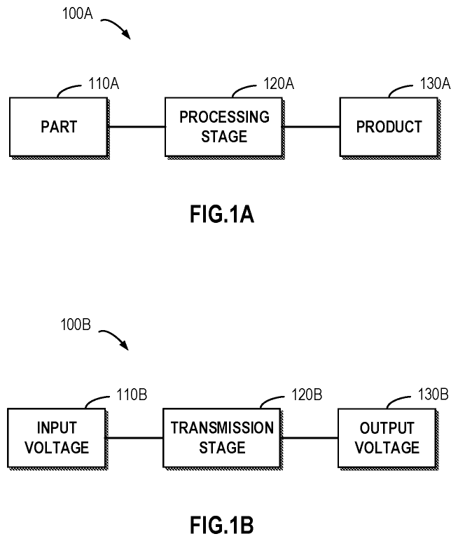

For the sake of description, first, an introduction is presented to an application environment of example implementations of the present disclosure with reference to FIGS. 1A and 1B. FIG. 1A schematically shows a block diagram 100A of an application environment in which example implementations of the present disclosure may be implemented. FIG. 1A shows a mechanical manufacturing process. Suppose it is desirable to process a part 110A into a product 130A with a predefined size, and the part 110A needs to undergo a processing stage 120A. The processing procedure of each part may involve different control parameters, such as tool speed, tool orientation, part size, smoothness and processing time. It is desirable to determine a causality between these processing parameters and the error of the final product 130A.

FIG. 1B schematically shows a block diagram 100B of a further application environment in which example implementations of the present disclosure may be implemented. FIG. 1B schematically shows a power transmission process. An input voltage 110B may undergo a transmission stage 120B so as to obtain an output voltage 130B at the destination. To reduce the loss during power transmission, ultra-high voltage circuit transmission mode can be used. At this point, the transmission stage 120B may involve different transmission parameters. It is desirable to determine a causality between these transmission parameters and power loss during transmission.

It will be understood that illustrated above are only examples in the mechanical manufacturing field and power transmission field. Example implementations of the present disclosure may further be applied in many other fields. For example, in many fields such as market research, manufacturing, healthcare, retail and so on, it is desirable to discover why and how things happen and to find policies that enable desired things to happen. For example, in the field of market research, people want to know which factors will affect customer satisfaction of telecom operators and how to improve customer satisfaction. In the field of product manufacturing, people want to know which factors will affect the product outputs and how to increase the product outputs. In the field of software development, people want to know which factors will affect the software failure rate and how to reduce the software failure rate. Therefore, it is desirable to provide a causal analysis system, and it is desired that the system discover the causality between multiple factors and further recommend a policy based on the causality, which affects an objective factor among multiple factors.

Multiple processing procedures (i.e., algorithms) have been proposed for determining the causality between multiple factors. It will be understood that each processing procedure has its own advantages and disadvantages. For example, using a processing procedure A to process data collected in the mechanical manufacturing environment as shown in FIG. 1A may determine an accurate causality. However, using the processing procedure A to process data collected in the power transmission environment as shown in FIG. 1B cannot determine an accurate causality. In existing technical solutions, technicians need to manually select a processing procedure for processing input data based on their own experience. If an improper processing procedure is selected, then a longer processing time and/or an inaccurate causality might be caused. At this point, a new processing procedure has to be selected, and then input data has to be re-processed using the new processing procedure. This will cause huge overheads of manpower and computing resources.

To solve the above problems and/or one or more other potential problems, example implementations of the present disclosure propose a technical solution for information processing. In the solution, based on input data to be processed, an algorithm based on which the input data is processed may be automatically determined. In this way, on the one hand, reliance on human labor may be reduced, and on the other hand, the performance and accuracy of future data processing procedures may be improved.

As used herein, first an introduction is presented to terms used in the present disclosure. The term “factor” is also referred to as “data.” The term “observation sample” refers to a group of observation values of multiple factors which can be observed directly, and a factor which can be observed directly is also referred to as an “observable factor” or “observable data.” The term “objective factor” refers to a factor which people want to affect. For example, in the above mechanical manufacturing field, observable factors may comprise various control parameters, and the objective factor may comprise the error of the final product. In the above power transmission environment, observable factors may comprise various transmission parameters, and the objective factor may comprise the final power loss.

For another example, in the market research field, observable factors may comprise factors related to customer attributes (such as customer level, customer phone number, etc.), factors related to customer behavior (such as monthly traffic consumption, ratio of free traffic, total cost of monthly traffic consumption, etc.), factors related to customer feedback (e.g., the number of complaints, customer satisfaction), and factors related to a policy (e.g., the number of reminders for a specific event, etc.). Customer satisfaction may be considered as the objective factor. As a further example, in the software development field, observable factors may comprise human resources for software development, the duration of software development, the number of functions, the number of code lines, the programming language for software development, the software failure rate, etc. For example, the software failure rate may be considered as the objective factor. Observation samples may comprise a group of observation values of observable factors.

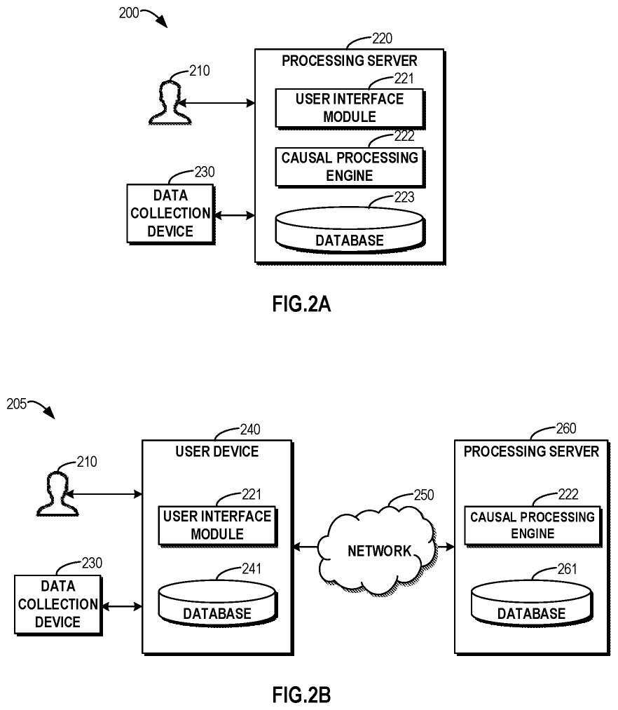

Example implementations of the present disclosure may be implemented in the form of a computer software application. FIG. 2A schematically shows a block diagram 200 of a computing environment in which example implementations of the present disclosure may be implemented. As depicted, the environment 200 may comprise a user 210, a processing server 220 and a data collection device 230. The processing server 220 may comprise a user interface module 221, a processing engine 222 and a database 223. It should be understood that the structure of the environment 200 and/or the processing server 220 is shown only for the illustration purpose, rather than suggesting any limitation on the scope of the present disclosure. Implementations of the present disclosure may also be applied to different environments with different structures and/or different processing servers with different components.

According to example implementations of the present disclosure, the data collection device 230 may be configured to automatically collect observation samples of multiple factors. Each observation sample may comprise a group of observation values of multiple factors. According to example implementations of the present disclosure, the data collection device 230 may comprise one or more sensors for collecting observation samples. Alternatively, according to example implementations of the present disclosure, the data collection device 230 may comprise one or more collection units for collecting observation values of different types of factors respectively.

According to example implementations of the present disclosure, the data collection device 230 may transmit collected observation samples to the processing server 220 for subsequent storage, processing and/or analysis. For example, the observation sample collected by the data collection device 230 may be transmitted to the processing server 220 via the user input interface module 221. Then, the observation sample may be transmitted from the user input interface module 221 to the processing engine 222 for subsequent storage, processing and/or analysis. For example, the processing engine 222 may select a processing procedure for processing the observation sample. Further, the processing engine 222 may run the selected processing procedure so as to discover the causality between multiple factors and/or perform an analysis based on the observation sample. Alternatively, the data collection device 230 may be omitted according to example implementations of the present disclosure. For example, the observation sample may be input by the user 210 to the server 220.

According to example implementations of the present disclosure, the user 210 may communicate with the processing system 220. For example, the user 210 may input the observation sample and/or other needed information to the processing server 220 via the user input interface module 221. The user input may be transmitted from the user input interface module 221 to the processing engine 222. According to example implementations of the present disclosure, in response to receiving the user input, the processing engine 222 may select a corresponding processing procedure for input data and present one or more feedback to the user 210 via the user input interface module 221. The processing engine 222 may store various received data to the database 223 for subsequent use. Further, the processing engine 222 may run the selected processing procedure so as to determine the causality between multiple factors in the input data.

FIG. 2B schematically shows a block diagram 205 of a further computing environment in which example implementations of the present disclosure may be implemented. As depicted, the environment 205 may comprise a user 210, a data collection device 230 (which is the same as or similar to the data collection device 230 shown in FIG. 2A), a user device 240 and a processing server 260. For example, the user device 240 may communicate with the processing server 260 via a network 250 (such as the Internet). It should be understood that the structure of the environment 205, the user device 240 and/or the processing server 220 is shown only for the illustration purpose, rather than suggesting any limitation on the scope of the present disclosure. Implementations of the present disclosure may also be applied to different environments, different user devices and/or different processing servers.

As used herein, the term “user device” may refer to any device with wireless or wired communication capability. Examples of the user device include, without limitation to, user equipment (EU), a personal computer, a desktop computer, a mobile phone, a cellular phone, a smart phone, a personal digital assistant (PDA), a portable computer, an image capturing device (such as a digital camera), a gaming device, a music storage and playback device, or an Internet device that enables wireless or wired Internet access and browsing.

As shown in FIG. 2B, the user device 240 may comprise a user interface module 221 (which is the same as or similar to the user interface module 221 shown in FIG. 2A) and a local database 241. According to example implementations of the present disclosure, user device 240 may receive observation samples from the data collection device 230 via the user interface module 221, and/or receive user input from the user 210 via the user interface module 221. The user device 240 may store received data at the local database 241 for subsequent use. The user device 240 may further transmit the received data to the processing server 260 via the network 250 for subsequent processing and/or analysis.

As shown in FIG. 2B, the processing server 260 may comprise a processing engine 222 (which is the same as or similar to the processing engine 222 shown in FIG. 2A) and a database 261. According to example implementations of the present disclosure, in response to receiving an observation sample of multiple factors, the processing engine 222 selects a corresponding processing procedure for the input data and presents one or more feedback to the user 210 via the user interface module 221. The processing engine 222 may store various received data to the database 261 for subsequent use. Further, the processing engine 222 may run the selected processing procedure so as to determine the causality between multiple factors in the input data.

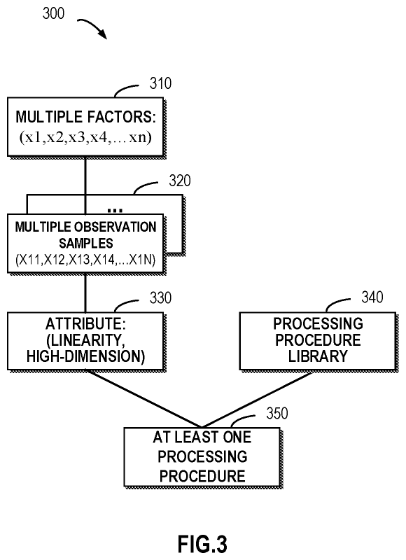

Now that computing environments for implementing example implementations of the present disclosure have been described with reference to FIGS. 2A and 2B, a brief description is presented below to the information processing procedure with reference to FIG. 3. This figure schematically shows a block diagram 300 of an information processing procedure according to one implementation of the present disclosure. As depicted, an application system may involve multiple factors 310. Suppose the number of multiple factors is denoted as n, then multiple factors may be denoted as x₁, x₂, x₃, x₄, . . . , xₙ. Multiple observation samples 320 associated with the multiple factors 310 may be obtained. Here, each observation sample among the multiple observation samples comprises multiple dimensions. As shown in FIG. 2, an observation sample may be denoted as (X11, X12, X13, X14, . . . , X1n). Each dimension in the observation sample may correspond to one factor among the multiple factors, i.e., each observation sample may comprise a group of observation values of the multiple factors. For example, data X11 at the first dimension is an observation value of the factor x₁, data X12 at the second dimension is an observation value of the factor x₂, etc.

At least one attribute 330 of the multiple observation samples 320 is obtained. Here, the attribute may involve a relationship (e.g., a linear relationship, a non-linear relationship) between the multiple factors, dimensions of the multiple factors, etc. Based on the at least one attribute of the multiple observation samples, at least one processing procedure 350 may be selected from a processing procedure library 340 to process the multiple observation samples. It will be understood that the number of processing procedures included in the at least one processing procedure 350 is not limited here. In fact, the at least one processing procedure 350 may comprise either a single processing procedure or multiple processing procedures.

It will be understood that the obtained multiple observation samples may have different attributes in different application systems. With example implementations of the present disclosure, a corresponding processing procedure may be selected based on the attribute 330 of the multiple observation samples. In this way, a processing procedure that best matches the attribute of the observation sample may be automatically determined without the need of any manual effort. Further, overheads of manual processing may be reduced, and it may be avoided that the selected processing procedure caused by manual error is not suitable for processing the received observation sample.

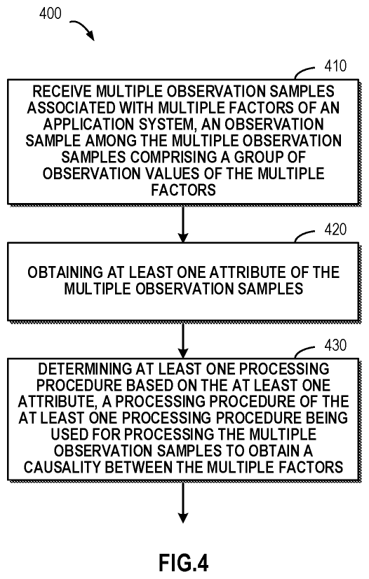

Hereinafter, more details of the example implementations of the present disclosure will be described with reference to FIG. 4, and this figure schematically shows a flowchart of a method 400 for information processing according to one implementation of the present disclosure. At block 410, multiple observation samples associated with multiple factors of an application system are received, here an observation sample among the multiple observation samples comprising a group of observation values of the multiple factors.

More details about the multiple factors 210 and the multiple observation samples 220 will be described with reference to the application environments shown in FIG. 1A and FIG. 1B, respectively. In the application system for mechanical manufacturing as shown in FIG. 1A, the multiple factors 210 may comprise multiple control parameters. For example, factors x₁ to x₅ may represent the tool speed, tool orientation, part size, smoothness and processing time, as well as error of a product represented by the factor x₆ in processing stages. At this point, each observation sample may comprise multiple data corresponding to the above factors. Examples of the multiple observation samples are schematically shown in Table 1 below.

TABLE 1
Examples of Multiple Observation samples

| factor x₁: | factor x₂: | | | factor x₅: | |
|---|---|---|---|---|---|
| tool | tool | factor x₃: | factor x₄: | processing | factor x₆: |
| speed | orientation | size | smoothness | time | error |
| X11 | X12 | X13 | X14 | X15 | X16 |
| X21 | X22 | X23 | X24 | X25 | X26 |
| . . . | . . . | . . . | . . . | . . . | . . . |
| Xm1 | Xm2 | Xm3 | Xm4 | Xm5 | Xm6 |

Suppose the number of the received multiple observation samples 220 is m, and each row in Table 1 represents one observation sample. The first row shows the observation sample of the first part in the process. That is, data X11, X12, X13, X14 and X15 in the first five dimensions correspond to the tool speed, the tool orientation, part size, smoothness and processing time, respectively, and data X16 in the last dimension corresponds to the error of the final product. Similarly, the m^{th} row shows the observation sample of the m^{th} part in the process. It will be understood that Table 1 merely illustrates an example data structure of the observation sample, and according to example implementations of the present disclosure, there may exist more factors. For example, the processing stage may further involve more control parameters in the roughing stage and the finishing stage, etc. Moreover, there may exist less factors according to example implementations of the present disclosure.

It will be understood that Table 1 merely illustrates an example data structure in the application system as shown in FIG. 1A. In other application systems, the observation sample may comprise more, less or different dimensions. For example, in the power transmission system shown in FIG. 1B, factors x₁ to x₅ may represent multiple transmission parameters in the transmission stage, and factor x₆ may represent power loss. It will be understood that although observation samples associated with 6 factors are illustrated above, according to example implementations of the present disclosure, observation samples may involve more or less factors.

According to example implementations of the present disclosure, data of multiple dimensions included in a given observation sample may be received from multiple sensors deployed in the application system respectively. For example, regarding the first observation sample in Table 1, data X11 to X16 may be collected from a measuring senor deployed at a tool in the machining system, etc. With example implementations of the present disclosure, it is possible to collect observation samples from existing sensors in the application system without the need of deploying extra sensors. In this way, the reuse performance of sensors in the application system may be improved.

At block 420, at least one attribute of the multiple observation samples is obtained. It will be understood that the attribute here may comprise contents in various respects. According to example implementations of the present disclosure, the attribute may comprise a relationship type of the multiple factors. The relationship type refers to the type of an association relationship between various factors. For example, the longer the polishing time of a part, the higher the smoothness; that is, the polishing time and the smoothness are in a linear relationship. For another example, the tool speed may affect the part size, whereas they do not have a linear dependency association relationship. With example implementations of the present disclosure, by differentiating association relationships between various factors, it helps to select a processing procedure that is more suitable for the relationship type, and further increase the accuracy of subsequent processing.

According to example implementations of the present disclosure, the attribute may comprise a dimension of the multiple factors. Here the dimension refers to the number of the multiple factors, e.g., in the example in Table 1, the dimension is 6. It will be understood that many processing procedures have been proposed so far, and these procedures are suitable to process different input data. For example, some processing procedures are more suitable to process high-dimensional data (e.g., observation samples whose dimensions are larger than or equal to 100); others are more suitable to process low-dimensional data (e.g., observation samples whose dimensions are smaller than 100). With example implementations of the present disclosure, by differentiating high-dimensional and low-dimensional observation samples, it helps to select a processing procedure that is more suitable for the dimension of the observation sample, and further increase the accuracy of subsequent processing.

According to example implementations of the present disclosure, the attribute may comprise a data type of the multiple factors. Here the data type refers to the type that each factor relates to, including at least any of: a continuous data type, a discrete data type and a mixed data types. In the example of Table 1, the tool speed, tool orientation, part size, smoothness, processing time and error are denoted by the real numbers, so the data type of the multiple factors is the continuous data type. In the example shown in FIG. 1B, suppose the factors x₁ to x₅ represent the “on”/“off” state of multiple buttons in the transmission device, and the factor x₆ represents whether the output voltage is normal, then at this point the multiple factors belong to the discrete data type. When the multiple factors comprise both of the continuous data type and the discrete data type (e.g., the factor x₆ represents the power loss), the multiple factors belong to the mixed data types.

Many processing procedures have been proposed for processing different types of input data. With example implementations of the present disclosure, by differentiating the data type of the input data, it helps to select a processing procedure that is more suitable for the data type, and further increase the accuracy of subsequent processing.

According to example implementations of the present disclosure, the attribute may comprise the number of the multiple observation samples. For example, in the example of Table 1, each row represents one observation sample, so the number of observation samples is m. It will be understood that when the number of observation samples differs, the corresponding processing approach is also different. According to example implementations of the present disclosure, the input data may be divided according to a comparison between the number and dimension of observation samples. If the number of observation samples is lower than the dimension thereof, then the input data has a small number of samples; otherwise the input data has a large number of samples. With example implementations of the present disclosure, by differentiating the large number of samples and the small number of samples, it helps to select a processing procedure that is more suitable for the number of samples, and further increase the accuracy of subsequent processing.

At block 430, at least one processing procedure is determined based on the at least one attribute. Here, one of the at least one processing procedure may be run to process the multiple observation samples, so that the causality between the multiple factors may be obtained. It will be understood that many processing procedures have been proposed, and thus multiple processing procedures might be found based on the given one or more attributes. At this point, multiple processing procedures may be executed respectively, so as to find one causality through each processing procedure. According to example implementations of the present disclosure, the user may select a causality that best meets requirements from multiple causalities.

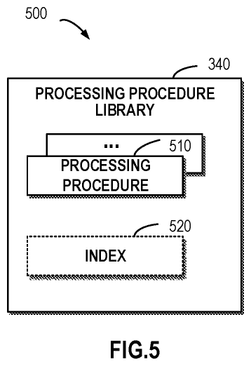

Description is presented below to contents of the processing procedure library with reference to FIG. 5. This figure schematically shows a block diagram 500 of the processing procedure library 340 according to one implementation of the present disclosure. The processing procedure library 340 may comprise a large number of processing procedures 510. According to example implementations of the present disclosure, the processing procedures 510 may be classified according to attributes, so as to find a processing procedure matching the attribute in the processing procedure library 340. For example, one or more labels may be set for each processing procedure. The label may comprise at least any of: the linearity, the non-linearity, the high dimension, the low dimension, the continuous data type, the discrete data type, the mixed data type, the large sample number, and the small sample number. A processing procedure that matches a feature may be searched for in the processing procedure library 340 based on the label.

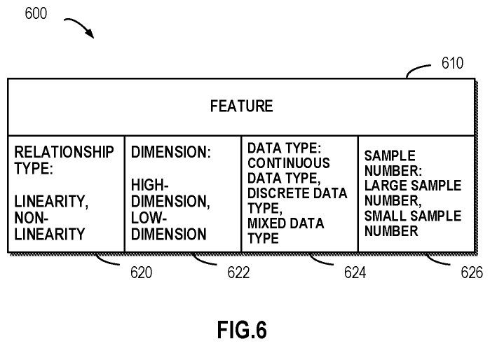

According to example implementations of the present disclosure, after the attribute of the multiple observation samples has been determined, a corresponding feature may be determined based on the attribute. FIG. 6 schematically shows a block diagram 600 of a data structure of a feature of the multiple observation samples according to one implementation of the present disclosure. As depicted, a feature 610 may comprise multiple fields: a relationship type 620, a dimension 622, a data type 624, and a sample number 626. The relationship type 620 may represent the relationship type between the multiple factors. Specifically, 0 may be used to represent a linear relationship, and 1 may be used to represent a non-linear relationship. The dimension 622 may represent a dimension of the multiple factors. Specifically, 0 may be used to represent high-dimensional data, and 1 may be used to represent low-dimensional data.

The data type 624 may represent the data type to which the multiple factors relate. Specifically, 0 may be used to represent the continuous data type, 1 may be used to represent the discrete data type, and 2 may be used to represent the mixed data type. The sample number 626 may represent the number of observation samples included in the input data: 0 may be used to represent the small sample number, and 1 may be used to represent the large sample number. Suppose the input data involves the linearity, low dimension, continuous data type and large sample number, then the feature of the input data may be represented as (0, 1, 0, 0).

It will be understood that FIG. 6 merely illustrates one way for generating the feature. According to example implementations of the present disclosure, the feature may be determined in another way. For example, the order between various fields in FIG. 6 may be changed. Alternatively and/or additionally, another value may be used to represent the specific meaning of each field.

Where the feature of the input data has been determined, at least one processing procedure that matches the feature may be selected from the processing procedure library 340. According to example implementations of the present disclosure, for the sake of search, the feature of the input data may be used as a keyword to compile an index 520 for various processing procedures. One or more processing procedures corresponding to a certain feature may be determined based on the index 520. With example implementations of the present disclosure, it is possible to increase the speed of searching in the processing procedure library 340 so as to improve the data processing efficiency.

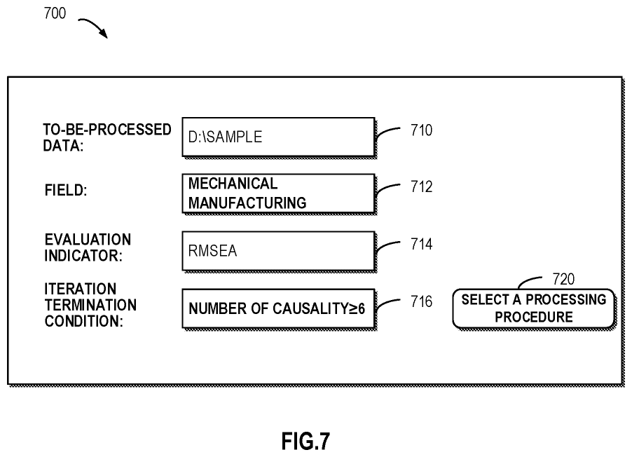

Description has been presented to how to automatically select at least one processing procedure that is suitable to process input data, without the need of manual intervention. According to example implementations of the present disclosure, the user only needs to specify input data to be processed and then can automatically obtain a processing procedure for processing the input data. FIG. 7 schematically shows a block diagram 700 of a user interface for information processing according to one implementation of the present disclosure. As depicted, the user may specify to-be-processed input data via a block 710.

According to example implementations of the present disclosure, user interaction is allowed. In this way, user preference may be received, and further a more friendly human-computer interaction mode may be provided. Specifically, the user may specify via a block 712 the field to which the to-be-processed input data belongs. According to example implementations of the present disclosure, the field to which the application system belongs may be received. At this point, at least one processing procedure for processing the multiple observation samples may be determined based on the previously determined at least one attribute and the received field. It will be understood that in the long-term research and development, technical experts might have accumulated abundant experience in processing input data in different fields. For example, a dedicated processing procedure may be developed for processing input data in a certain field. At this point, a more suitable processing procedure may be selected based on the field. According to example implementations of the present disclosure, the feature 610 shown in FIG. 6 may comprise a further dimension “field,” so as to quickly find a matching processing procedure in the processing procedure library 340.

Description has been presented to how to determine at least one processing procedure. According to example implementations of the present disclosure, the found at least one processing procedure may be executed. Specifically, each processing procedure of the at least one processing procedure may be run on the multiple observation samples. One causality may be provided based on each processing procedure, so at least one causality may be provided based on the at least one processing procedure.

According to example implementations of the present disclosure, while running each processing procedure, the user may be allowed to specify a group of evaluation indicators for evaluating the causality. For example, the user may input a group of evaluation indicators via a block 714 as shown in FIG. 7. The evaluation indicator may comprise contents in various respects, including without limitation to, RMSEA, RMR, TLI, AIC, BIC, etc. RMSEA stands for Root Mean Square Error of Approximation; the closer to 0 a value of the indicator, the higher the fitness of causality. RMR stands for Root Mean Square Residual, TLI stands for Tucker-Lewis Index, AIC stands for Akaike Information Criterion, and BIC stands for Bayesian Information Criterion. All these indicators are common standards for evaluating the fitness of causality. It will be understood that illustrated above are only examples which can be used as evaluation indicators, and according to example implementations of the present disclosure, another evaluation indicator may further be selected.

According to example implementations of the present disclosure, a control parameter for setting the processing procedure may be determined based on the received group of evaluation indicators. Subsequently, the processing procedure may be set based on the control parameter and may be run on the multiple observation samples. The causality may be obtained step by step, and specifically, the above process may be iteratively executed in multiple rounds. According to example implementations of the present disclosure, the control parameter may be adjusted based on the group of evaluation indicators so as to obtain the adjusted control parameter. In one example, the user may adjust at least any of: nlambda, qlimit, Lambda min, etc.

It will be understood that the above parameters are control parameters for adjusting the processing procedure, and those skilled in the art may consult the specification of corresponding processing procedures to determine the specific meaning, which will not be detailed. Suppose it is desirable to evaluate the causality based on RMSEA, then better RMSEA may be obtained by increasing the value of nlambda (e.g., nlambda=50). According to example implementations of the present disclosure, the user may determine whether to continuously increase nlambda during constant iteration. Suppose the user desires the evaluation indicator to be based on running efficiency, then qlimit may be reduced (e.g., qlimit=500). In this way, higher running efficiency may be obtained.

According to example implementations of the present disclosure, the causality may be iteratively updated based on the adjusted parameter. During updating the causality, the causality which is found in each iteration may be displayed to the user. According to example implementations of the present disclosure, the found causality may be presented in various ways. For example, the causality may be presented in a directed acyclic graph (DAG).

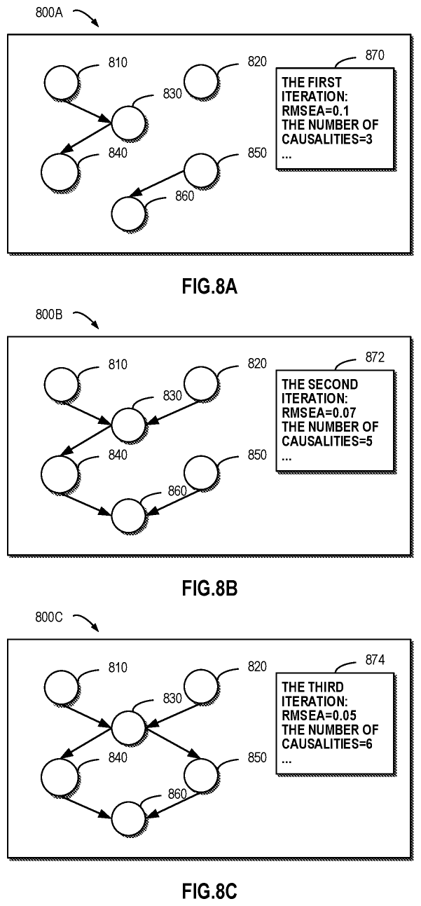

Examples of presenting the causality in the directed acyclic graph will be described with reference to FIGS. 8A to 8C. FIG. 8A schematically shows a block diagram 800A of a user interface for displaying a causality according to one implementation of the present disclosure. As shown on the left of FIG. 8A, nodes 810 to 860 represent the multiple factors x₁ to x₆ in Table 1, and an edge in the figure represents that two factors have a causality. For example, there is an edge between the nodes 810 and 830, which indicates that factor x₁ is the direct cause of factor x₃. Prompt information 870 on the right of FIG. 8A shows related information of current iteration: the causality shown currently is a result of the first iteration, the evaluation indicator RMSEA=0.1, and the number of obtained causality is 3 (i.e., the number of edges in DAG).

It will be understood that FIG. 8A merely shows one example of causality. According to example implementations of the present disclosure, though not shown in FIG. 8A, a weight of causality may further be displayed; the larger the weight, the stronger the causality. According to example implementations of the present disclosure, the found causality may be presented in a matrix. At this point, multiple dimensions of the matrix represent the multiple factors, respectively, and an element of the matrix represents a weight of causality between two factors corresponding to elements among the multiple factors. The causality may be presented based on a matrix M below, and the matrix M represents the same causality as the DAG shown in FIG. 8A.

$$M = [ \begin{matrix}0 & 0 & {w}_{13} & 0 & 0 & 0 \\ 0 & 0 & 0 & 0 & 0 & 0 \\ 0 & 0 & 0 & {w}_{34} & 0 & 0 \\ 0 & 0 & 0 & 0 & 0 & 0 \\ 0 & 0 & 0 & 0 & 0 & {w}_{56} \\ 0 & 0 & 0 & 0 & 0 & 0\end{matrix} ]$$

In the matrix M, the value “0” indicates that two factors do not have a causality, and a non-zero value indicates that two factors have a causality, and the size of the value represents the strength of the causality. For example, w₁₃ represents the weight of the factors x₁ and x₃, w₃₄ represents the weight of the factors x₃ and x₄, etc. With example implementations of the present disclosure, by presenting the found causality in the DAG or the matrix, it is possible to facilitate the user to understand the causality between multiple factors included in the application system, and further adjust the running of the application system based on the found causality.

According to example implementations of the present disclosure, the user may specify a condition for terminating the iteration, e.g., may specify the termination condition via the block 716 shown in FIG. 7. It may be specified that the iteration stops when the number of obtained causality is larger than a specified threshold, e.g., may specify that the iteration stops after 6 (or another number) causalities are obtained. Alternatively and/or additionally, it may be specified that the iteration stops when a certain evaluation indicator meets a specified threshold, e.g., may specify that the iteration stops when RMSEA 0.05 (or another value), etc.

According to example implementations of the present disclosure, multiple termination conditions may be specified, and a relationship between the multiple termination conditions may be specified. For example, it may be specified that the iteration stops when all the termination conditions are met, or it may be specified that the iteration stops when any of the termination conditions is met. A stop criterion may be received; during the iteration, if updated causality meets the stop criterion, then the iteration stops and updated causality is provided.

Suppose the user specifies that the iteration stops when the number of causalities ≥6. At this point, the number of causalities after the first iteration is 3, so the second iteration must be executed. FIG. 8B schematically shows a block diagram 800B of a user interface for displaying a causality according to one implementation of the present disclosure. In the figure, after the second iteration, one edge is added between nodes 820 and 830, and one edge is added between nodes 840 and 860. Prompt information 872 shows related information of the second iteration: RMSEA=0.07, and the number of causalities is 5. It will be understood that the prompt information 872 outputted here is determined based on updated causality shown in FIG. 8B. Here, various indicators of the updated causality have been improved: RMSEA reduces from 0.1 to 0.07, and the number of found causality increases from 3 to 5. Since the number of causalities still does not meet the stop criterion, the third iteration will be executed.

FIG. 8C schematically shows a block diagram 800C of a user interface for displaying a causality according to one implementation of the present disclosure. In the figure, after the third iteration, one edge is added between nodes 840 and 850. Prompt information 874 shows related information of the third iteration: RMSEA=0.05, and the number of causalities is 6. Since the number of causalities meets the stopping criterion, the iteration stops.

Examples on stopping iteration based on the stop criterion have been described with reference to FIGS. 8A to 8C. According to example implementations of the present disclosure, the user may determine whether to execute subsequent iteration, based on the displayed causality and related information. Suppose the user believes that the causality shown in FIG. 8B has met the requirement, then the iteration may stop immediately.

According to example implementations of the present disclosure, the user may manually adjust the obtained causality. Generally speaking, with the long-term observation of the multiple factor, some experience might have been accumulated regarding whether two factors have a causality. Constraints on the causality between two factors may be referred to as expert knowledge. After the causality is obtained, it is possible to use expert knowledge to verify whether the obtained causality conforms to known experience.

Suppose the expert knowledge indicates that the factors x₃ and x₅ do not have a causality, then the user may manually delete the edge between the nodes 830 and 850 in FIG. 8C. Subsequently, the causality may be adjusted based on the delete operation of the user. Since the expert knowledge reflects professional experience accumulated by people, by determining the causality based on the expert knowledge, on the one hand, the computation load of the process may be reduced, and on the other hand, the obtained causality may better conform to historical experience.

According to example implementations of the present disclosure, the running of the application system may be adjusted based on the obtained causality. According to example implementations of the present disclosure, failures of the application system may further be eliminated based on the causality. Specifically, regarding the machining system shown in FIG. 1A, a causality between respective control attributes and the product error has been determined based on the above method. The control attributes that most affects the product error may be adjusted first based on the found causality.

According to example implementations of the present disclosure, the performance of the application system may be improved based on the causality. Specifically, cause nodes in the causality of the application system may be affected by adjusting, monitoring and other means, and then the performance of the application system may be improved. In addition, the improvement or performance boost of the application system may be promoted by automatically outputting the analysis result (the causality) if a predetermined condition is met. As an example, for the power transmission system shown in FIG. 1B, suppose that the causality between respective transmission parameters and the power loss has been determined based on the above method, then the control parameters that exert the greatest impact on power loss may be adjusted first based on the found causality. In this way, the performance of the power transmission system may be increased.

It will be understood although how to select a processing procedure for input data from various application systems and determine the causality based on the selected processing procedure has been described by taking the mechanical manufacturing system and the power transmission system as specific examples of the application system, the method described above may further be applied to another application system. For example, market research data may be collected, and to-be-processed data may be input via the block 710 in the interface as shown in FIG. 7. With example implementations of the present disclosure, an appropriate processing procedure may be automatically selected for the to-be-processed data. Further, while determining the to-be-processed data based on the selected processing procedure, the user is allowed to input the evaluation indicator for evaluating the causality. In this way, the causality may be iteratively determined in a direction that better satisfies the evaluation indicator.

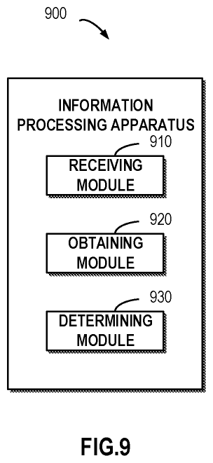

Details about the method for information processing have been described with reference to FIGS. 2A to 8C. Hereinafter, various modules in an apparatus for information processing will be described with reference to FIG. 9. This figure schematically shows a block diagram of an apparatus 900 for information processing according to one implementation of the present disclosure.

According to example implementations of the present disclosure, an apparatus for information processing is provided. The apparatus comprises: a receiving module configured to receive multiple observation samples associated with multiple factors of an application system, an observation sample among the multiple observation samples comprising a group of observation values of the multiple factors; an obtaining module configured to obtain at least one attribute of the multiple observation sample; and a determining module configured to determine at least one processing procedure based on the at least one attribute, a processing procedure of the at least one processing procedure being used for processing the multiple observation samples to obtain a causality between the multiple factors.

According to example implementations of the present disclosure, the obtaining module is configured to obtain at least any of: a relationship type of the multiple factors; a dimension of the multiple factors; a data type of the multiple factors; and the number of the multiple observation samples.

According to example implementations of the present disclosure, the relationship type comprises at least any of a linear relationship and a non-linear relationship; the dimension comprises at least any of a high dimension and a low dimension; the data type comprises at least any of a continuous data type, a discrete data type and a mixed data type; and the number comprises at least any of a large sample number and a small sample number.

According to example implementations of the present disclosure, the determining module comprises a selecting module configured to select from a processing procedure library the at least one processing procedure that matches the at least one attribute.

According to example implementations of the present disclosure, the selecting module comprises: a generating module configured to generate a feature of the multiple observation samples based on the at least one attribute; and a lookup module configured to look up the at least one processing procedure in the processing procedure library based on the feature.

According to example implementations of the present disclosure, the determining module comprises: a field receiving module configured to receive an instruction on a field to which the application system belongs; and the determining module is further configured to determine the at least one processing procedure for processing the multiple observation samples based on the at least one attribute and the field.

According to example implementations of the present disclosure, the at least one processing procedure comprises multiple processing procedures, and the apparatus further comprises a providing module configured to use the multiple processing procedures to process the multiple observation samples respectively, so as to provide multiple causalities between the multiple factors, the causality among the multiple causalities being provided by using a processing procedure among the multiple processing procedures to process the multiple observation samples.

According to example implementations of the present disclosure, the providing module comprises: an evaluation indicator receiving module configured to, for a processing procedure among the multiple processing procedures, receive an instruction on specifying a group of evaluation indicators for evaluating the causality; a setting module configured to determine a control parameter for setting the processing procedure based on the group of evaluation indicators; and a causality determining module configured to determine the causality based on the control parameter and the multiple observation samples.

According to example implementations of the present disclosure, the causality determining module comprises: an adjustment module configured to adjust the control parameter based on the group of evaluation indicators; and an updating module configured to update the causality based on the adjusted control parameter.

According to example implementations of the present disclosure, the updating module comprises: a stop criterion receiving module configured to receive an instruction on a stop criterion for stopping an iteration; and a stopping module configured to, in response to the updated causality meeting the stop criterion, stop the iteration to provide the updated causality.

According to example implementations of the present disclosure, the updating module further comprises: an output module configured to update the updated causality; a feedback receiving module configured to receive an instruction on feedback on the updated causality; and a causality adjustment module configured to adjust the causality based on the feedback.

According to example implementations of the present disclosure, the output module is configured to further comprise: an information output module configured to output information associated with the group of evaluation indicators, the information being determined based on the updated causality.

According to example implementations of the present disclosure, the output module comprises at least any of: a graph presenting module configured to present the causality in a directed acyclic graph, multiple nodes in the directed acyclic graph representing the multiple factors respectively, and an edge in the directed acyclic graph representing a causality between two factors among the multiple factors; and a matrix presenting module configured to present the causality in a matrix, multiple dimensions of the matrix representing the multiple factors respectively, and an element of the matrix representing a weight of causality between two factors corresponding to the element among the multiple factors.

According to example implementations of the present disclosure, the multiple factors represent multiple device control parameters of the application system.

According to example implementations of the present disclosure, the group of observation values included in the observation sample are collected from one or more sensors deployed in the application system; and the apparatus further comprises: a causality providing module configured to provide the causality to the application system.

Multiple example implementations of processing the input data based on the determined at least one processing procedure have been described above. According to example implementations of the present disclosure, the multiple processing procedures may be directly run, and multiple causalities may be obtained. In this way, the multiple causalities may be provided to the user for selection.

Specifically, multiple observation samples associated with multiple factors of an application system may be received. Here, an observation sample among the multiple observation samples comprises a group of observation values of the multiple factors. Subsequently, multiple processing procedures may be used to process the multiple observation samples so as to determine multiple causalities between the multiple factors. Specifically, each processing procedure may be run on the multiple observation samples so as to obtain the multiple causalities. It will be understood that the multiple processing procedures here may be all or part of processing procedures included in a processing procedure library.

According to example implementations of the present disclosure, the multiple processing procedures may be selected from the processing procedure library based on at least one attribute of the multiple observation samples. Specifically, the at least one attribute comprises obtaining at least any of: a relationship type of the multiple factors; a dimension of the multiple factors; a data type of the multiple factors; and the number of the multiple observation samples.

According to a further example implementation of the present disclosure, a final causality between the multiple factors may be determined from the obtained multiple causalities based on the at least one attribute of the multiple observation samples. The determining comprises: selecting at least one causality from the obtained multiple causalities as the final causality, or selecting from the obtained multiple causalities and adjusting the at least one causality based on the at least one attribute, as the final causality between the multiple factors, wherein an order between the selecting and the adjusting may be changed.

According to example implementations of the present disclosure, user interaction may be allowed. For example, an instruction for specifying a field to which the application system belongs may be received. At this point, the corresponding multiple processing procedures may be selected from the processing procedure library based on the specified field.

According to example implementations of the present disclosure, the user may be allowed to control the running of the multiple processing procedures. Specifically, an instruction on a running parameter for running the multiple processing procedures may be received. Here, the running parameter may comprise at least any of: an evaluation criterion for evaluating the multiple causalities, a standard which the multiple causalities should meet, and feedback on the multiple causalities. Subsequently, the running of the multiple processing procedures may be controlled based on the multiple running parameters. For example, a control parameter of the multiple processing procedures may be determined and/or updated based on the evaluation indicator, whether to stop iteration may be determined based on a criterion specified by the user, a structure of the causality may be adjusted based on the feedback of the user.

According to a further example implementation of the present disclosure, the final causality between the multiple factors may be determined from the obtained multiple causalities based on the running parameter. The determining comprises: selecting at least one causality from the obtained multiple causalities as the final causality between the multiple factors, or selecting from the obtained multiple causalities and adjusting the at least one causality based on the running parameter, as the final causality between the multiple factors, wherein an order between the selecting and the adjusting may be changed.

It will be understood that illustrated above are merely examples of receiving input from the user after running the multiple processing procedures. Specific details about each step in these examples are similar to the methods described with reference to FIGS. 3 to 8C and thus are not detailed.

According to example implementations of the present disclosure, an apparatus for information processing is provided. The apparatus comprises: a receiving module configured to receive multiple observation samples associated with multiple factors of an application system, an observation sample among the multiple observation samples comprising a group of observation values of the multiple factors; and a determining module configured to use multiple processing procedures to process the multiple observation samples so as to determine multiple causalities between the multiple factors, the causality among the multiple causalities being obtained based on a processing procedure among the multiple processing procedures.

According to example implementations of the present disclosure, the multiple processing procedures are obtained based on at least one attribute of the multiple observation samples, the at least one attribute comprising obtaining at least any of: a relationship type of the multiple factors; a dimension of the multiple factors; a data type of the multiple factors; and the number of the multiple observation samples.

According to example implementations of the present disclosure, the apparatus further comprises: an operation instruction receiving module configured to receive or obtain an operation instruction, the operation instruction indicating information on a field to which the application field belongs; and wherein the multiple processing procedures are obtained based on the operation instruction.

According to example implementations of the present disclosure, the apparatus further comprises: a running parameter receiving module configured to receive an instruction on a running parameter for running the multiple processing procedures, the running parameter comprising at least any of: an evaluation criterion for evaluating the multiple causalities, a standard which the multiple causalities should meet, and feedback on the multiple causalities; and the apparatus further comprises: a control module configured to control the running of the multiple processing procedures based on the running parameter.

According to example implementations of the present disclosure, the determining module is further configured to: re-determine a causality between the multiple factors based on the running parameter.

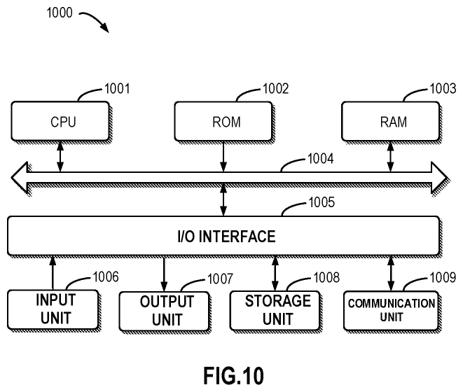

FIG. 10 schematically shows a block diagram of a device for information processing according to one implementation of the present disclosure. As depicted, the device 1000 includes a central processing unit (CPU) 1001, which can execute various suitable actions and processing based on the computer program instructions stored in the read-only memory (ROM) 1002 or computer program instructions loaded in the random-access memory (RAM) 1003 from a storage unit 1008. The RAM 1003 can also store all kinds of programs and data required by the operations of the device 1000. CPU 1001, ROM 1002 and RAM 1003 are connected to each other via a bus 1004. The input/output (I/O) interface 1005 is also connected to the bus 1004.

A plurality of components in the device 1000 are connected to the I/O interface 1005, including: an input unit 1006, such as a keyboard, mouse and the like; an output unit 1007, e.g., various kinds of displays and loudspeakers etc.; a storage unit 1008, such as a magnetic disk and optical disk, etc.; and a communication unit 1009, such as a network card, modem, wireless transceiver and the like. The communication unit 1009 allows the device 1000 to exchange information/data with another device via the computer network, such as Internet, and/or various telecommunication networks.

The above described process and treatment, such as the method 400 can be executed by the processing unit 1001. For example, in some example implementations, the method 400 can be implemented as a computer software program tangibly included in the machine-readable medium, e.g., the storage unit 1008. In some implementations, the computer program can be partially or fully loaded and/or mounted to the device 1000 via ROM 1002 and/or the communication unit 1009. When the computer program is loaded to the RAM 1003 and executed by the CPU 1001, one or more steps of the above described method 400 can be implemented.

According to example implementations of the present disclosure, a device for information processing is provided. The device comprises a processor, the processor being configured to execute the method described above.

According to example implementations of the present disclosure, an electronic device is provided, comprising: at least one processing unit; at least one memory, coupled to the at least one processing unit and storing instructions to be executed by the at least one processing unit, the instructions, when executed by the at least one processing unit, causing the device to perform the method described above.

According to example implementations of the present disclosure, a computer-readable storage medium is provided, containing computer-readable program instructions stored thereon which are used to perform the method described above.

The present disclosure can be a method, device, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but is not limited to, an electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can include copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages consist of object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where a remote computer is involved, the remote computer can be connected to the user computer via any type of network, including local area network (LAN) and wide area network (WAN), or to the external computer (e.g., connected via Internet using an Internet service provider). In some implementations, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow charts and/or block diagrams of method, apparatus (system) and computer program products according to implementations of the present disclosure. It should be understood that each block of the flow charts and/or block diagrams and the combination of various blocks in the flow charts and/or block diagrams can be implemented by computer-readable program instructions.

The computer-readable program instructions can be provided to the processing unit of a general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions contains an article of manufacture, including instructions for implementing various aspects of the functions/actions stipulated in one or more blocks of the flow chart and/or block diagram.

The computer-readable program instructions can also be loaded into a computer, other programmable data processing apparatuses or other devices, so as to execute a series of operation steps on the computer, the other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow charts and block diagrams in the drawings illustrate system architecture, functions and operations that may be implemented by system, method and computer program products according to a plurality of implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order depending on the functions involved. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various implementations of the present disclosure have been described above and the above description is only exemplary rather than exhaustive and is not limited to the implementations of the present disclosure. Many modifications and alterations, without deviating from the scope and spirit of the explained various implementations, are obvious for those skilled in the art. The selection of terms in the text aims to best explain principles and actual applications of each implementation and technical improvements made in the market by each implementation, or enable others of ordinary skill in the art to understand implementations of the present disclosure.

1. A method for information processing, comprising:
receiving multiple observation samples associated with multiple factors of an application system, an observation sample among the multiple observation samples comprising a group of observation values of the multiple factors;
obtaining at least one attribute of the multiple observation samples; and
determining at least one processing procedure based on the at least one attribute, a processing procedure of the at least one processing procedure being used for processing the multiple observation samples to obtain a causality between the multiple factors.

2. The method of claim 1, wherein obtaining the at least one attribute of the multiple observation samples comprises obtaining at least any of:
a relationship type of the multiple factors;
a dimension of the multiple factors;
a data type of the multiple factors; and
the number of the multiple observation samples.

3. The method of claim 2, wherein
the relationship type comprises at least any of a linear relationship and a non-linear relationship;
the dimension comprises at least any of a high dimension and a low dimension;
the data type comprises at least any of a continuous data type, a discrete data type and a mixed data type; and
the number comprises at least any of a large sample number and a small sample number.

4. The method of claim 1, wherein determining the at least one processing procedure comprises: selecting from a processing procedure library the at least one processing procedure that matches the at least one attribute.

5. The method of claim 4, wherein selecting the at least one processing procedure comprises:
generating a feature of the multiple observation samples based on the at least one attribute; and
looking up the at least one processing procedure in the processing procedure library based on the feature.

6. The method of claim 1, wherein determining the at least one processing procedure further comprises:
receiving an instruction on a field to which the application system belongs; and
determining the at least one processing procedure for processing the multiple observation samples based on the at least one attribute and the field.

7. The method of claim 1, wherein the at least one processing procedure comprises multiple processing procedures, and the method further comprises: using the multiple processing procedures to process the multiple observation samples respectively, so as to provide multiple causalities between the multiple factors, a causality among the multiple causalities being provided by using a processing procedure among the multiple processing procedures to process the multiple observation samples.

8. The method of claim 7, wherein providing the multiple causalities comprises: for a processing procedure among the multiple processing procedures,
receiving an instruction on specifying a group of evaluation indicators for evaluating a causality;
determining a control parameter for setting the processing procedure based on the group of evaluation indicators; and
determining the causality based on the control parameter and the multiple observation samples.

9. The method of claim 8, wherein determining the causality comprises:
adjusting the control parameter based on the group of evaluation indicators; and
updating the causality based on the adjusted control parameter.

10. The method of claim 9, wherein updating the causality comprises:
receiving an instruction on a stop criterion for stopping an iteration; and
in response to the updated causality meeting the stop criterion, stopping the iteration to provide the updated causality.

11. The method of claim 9, wherein updating the causality further comprises:
updating the updated causality;
receiving an instruction on feedback on the updated causality; and
adjusting the causality based on the feedback.

12. The method of claim 11, wherein outputting the updated causality further comprises: outputting information associated with the group of evaluation indicators, the information being determined based on the updated causality.

13. The method of claim 11, wherein outputting the updated causality comprises at least any of:
presenting the causality in a directed acyclic graph, multiple nodes in the directed acyclic graph representing the multiple factors respectively, and an edge in the directed acyclic graph representing a causality between two factors among the multiple factors; and
presenting the causality in a matrix, multiple dimensions of the matrix representing the multiple factors respectively, and an element of the matrix representing a weight of a causality between two factors corresponding to the element among the multiple factors.

14. The method of claim 1, wherein the multiple factors represent multiple device control parameters of the application system.

15. The method of claim 8, wherein the group of observation values included in the observation sample are collected from one or more sensors deployed in the application system; and the method further comprises: providing the causality to the application system.

16. A device for information processing, comprising a processor, the processor being configured to:
receive multiple observation samples associated with multiple factors of an application system, an observation sample among the multiple observation samples comprising a group of observation values of the multiple factors;
obtain at least one attribute of the multiple observation samples; and
determine at least one processing procedure based on the at least one attribute, a processing procedure of the at least one processing procedure being used to process the multiple observation samples so as to obtain a causality between the multiple factors.

17-32. (canceled)

33. A method for information processing, comprising:
receiving multiple observation samples associated with multiple factors of an application system, an observation sample among the multiple observation samples comprising a group of observation values of the multiple factors;
using multiple processing procedures to process the multiple observation samples, respectively, so as to determine multiple causalities between the multiple factors, a causality among the multiple causalities being obtained based on a processing procedure among the multiple processing procedures.

34-38. (canceled)
